(19) United States
(12) Patent Application Publication
(10) Pub. No.: US 2009/0109576 A1
(43) Pub. Date: Apr. 30, 2009

(54) HEAD SUPPORT DEVICE AND DISK DEVICE WITH THE SAME

(75) Inventor: Hideki Kuwajima, Kyoto (JP)

Correspondence Address: WENDEROTH, LIND & PONACK L.L.P., 1030 15th Street, N.W., Suite 400 East, Washington, DC, 20005-1503, US

(73) Assignee: MATSUSHITA ELECTRIC INDUSTRIAL CO., LTD., Osaka, JP (JP)

(21) Appl. No.: 11/910,489

(22) PCT Filed: Apr. 20, 2006
(86) PCT No.: PCT/JP2006/308284

§ 371 Date: Oct. 2, 2007

(30) Foreign Application Priority Data
Apr. 22, 2005 (JP) 2005-124631

(51) Int. Cl. G11B 5/56

(52) U.S. Cl. 360/294.5; G9B/5.201

(57) ABSTRACT

A head supporting arm coupled at one end with a head slider is supported so as it can revolve in parallel to the surface of a recording medium around a shaft for horizontal revolution, at the same time can revolve perpendicularly to the surface of recording medium around an axis for vertical revolution, which axis for vertical revolution being a straight line which contains the summit points of a pair of pivots. Further, voice coil unit is structured so as the center line of voice coil makes an angle θ to the center line of head supporting arm, and the center of gravity in centroid setting portion of the voice coil unit locates at a place which is at least in the direction anti-clockwise around the center of shaft for horizontal revolution with respect to the center line of head supporting arm. The above-configured head supporting gear provides such advantages as the downsizing of a disk drive, stabilized frequency characteristics, easier setting of load to the head at high accuracy level.

### TECHNICAL FIELD

The present invention relates to a head supporting gear for supporting a floating head of a disk drive device; more specifically, a head supporting gear provided with a mechanism for stabilizing the frequency characteristics at resonance frequency. The present invention relates also to a disk drive device which incorporates the head supporting gear.

### BACKGROUND ART

There have been proposed a number of such head supporting gears which provide a minimum and sufficient load to the head while maintaining a high flexibility and a very high shock-withstanding property. These head supporting gears are structured so that they can revolve around a shaft for horizontal revolution in the direction parallel to the surface of a recording medium and, at the same time, can revolve around an axis for vertical revolution in the direction perpendicular to the surface of recording medium.

In the following, a head supporting gear is described as an example representing those conventional head supporting gears used in hard disk drives or the like magnetic disk drives having floating type head, referring to drawings.

FIG. 22 is a plan view which shows key part of a magnetic disk drive incorporating a conventional head supporting gear. FIG. 23 is a side view which shows the structure of head supporting gear used in a magnetic disk drive. FIG. 24 is a plan view which shows the structure of head supporting arm unit, which unit being a constituent part of the head supporting gear; FIG. 25 shows its exploded perspective view. The disk drive is shown in FIG. 22 with its upper lid taken away and upper yoke partially removed.

In FIG. 22, recording medium 4 having a layer of recording medium on the surface is affixed on rotor hub 3 which is fixed to revolving shaft 2 of a spindle motor (not shown) revolving around revolving center 1. Head supporting arm unit 221, or a swing arm for holding a signal conversion element, is pivotally supported via bearing 6 so as the supporting arm can freely revolve around shaft for horizontal revolution 5. Head supporting arm unit 221 can revolve horizontally around center 5a of shaft for horizontal revolution 5 in virtually parallel with the surface of recording medium 4.

Head supporting arm unit 221 is provided at one end of head supporting arm 8 with tab 8a. The unit includes also head slider 9 mounted with a magnetic head, or signal conversion element (not shown), which is disposed via gimbals (not shown) at the shaft for horizontal revolution 5 side of tab 8a. Voice coil 10 is provided at the other end, viz. the end opposite to tab 8a with respect to shaft for horizontal revolution 5. Head supporting arm unit 221 is revolved around shaft for horizontal revolution 5 by voice coil 10 in parallel with the surface of recording medium 4 along the radial direction.

Upper yoke 222 mounted with magnet 11 is disposed above voice coil 10 so that the magnet opposes to voice coil 10. The upper yoke is fixed to chassis or other member of cabinet (not shown) in the side opposite to recording medium 4 with respect to head supporting arm unit 221 on which voice coil 10 is mounted. Lower yoke 223 is disposed so that it opposes to voice coil 10 from the underneath, and fixed to chassis or other member of cabinet locating at the recording medium 4 side with respect to head supporting arm unit 221 on which voice coil 10 is mounted. Lower yoke 223 and upper yoke 222 are disposed face to face with voice coil 10 in between.

Voice coil 10, magnet 11 opposing to voice coil 10, upper yoke 222 which is mounted with magnet 11, and lower yoke 223 constitute a voice coil motor (hereinafter referred to as VCM). Head supporting gear 220 shown in FIG. 23 is formed of head supporting arm unit 221, magnet 11 which is attached fixed to upper yoke 222 and opposes to voice coil 10 of head supporting arm unit 221, and lower yoke 223.

Ramp block 15 having ramp section 14 provided with a guide portion is attached to chassis or other member of cabinet, as shown in FIG. 22. Tab 8a of head supporting arm unit 221 makes contact with ramp section 14 to guide head supporting arm unit 221 in the direction up/down.

When an electric current is delivered to voice coil 10 which has been disposed opposed to magnet 11, VCM starts revolving head supporting arm unit 221 in the radial direction of recording medium 4. Head supporting arm unit 221 revolves around shaft for horizontal revolution 5 to sweep the data recording region of revolving recording medium 4 from the above, during a magnetic disk drive is in operation. While it is out of work, head supporting arm unit 221 is revolved clockwise until it reaches a certain specific position, or a shelter, of ramp section 14.

In order to curb head supporting arm unit 221 from making an over swing, clockwise or anti-clockwise, crash-stops 16, 17 are provided on chassis, cabinet or other structural member.

Now in the following, the structure of head supporting gear 220 is described referring to FIGS. 23, 24 and 25.

Reference is made to FIGS. 23, 24 and 25, head supporting arm 8 is provided at one end with tab 8a, and at the other end with opening 8b (ref. FIG. 25). At the tab 8a side, head slider 9 which is mounted with a magnetic head (not shown) is attached via gimbals 21. Head supporting arm 8 is provided at the lower surface with dimple 8c so as it makes contact with head slider 9 at the vicinity of the center. Head slider 9 is attached to head supporting arm 8 via gimbals 21. By having dimple 8c in contact with the upper surface (a surface reverse to the surface mounted with the magnetic head) of head slider 9 at an approximate center, gimbals 21 can make head slider 9 to comply flexibly with recording medium 4, including vibrations during operation in the rolling or pitching directions, etc.

Voice coil 10 is attached to coil holder 224 which has opening 224a, to complete voice coil unit 225. Although head supporting arm 8 and voice coil unit 225 have been described as separate items independent to each other, they may of course be integrated into a single member.

Referring to FIG. 25, plate spring 24, which is an elastic member of an approximate ring shape, is fixed at one end to the lower surface (the surface on which head slider 9 is attached) of head supporting arm 8. Plate spring 24 is attached at the other end of the upper surface (the same surface at which it is fixed to head supporting arm 8) with spring fixing member 25 of an approximate crescent shape.

Bearing 27, which has a cylindrical shape having flange, is consisting of flange 27a, screw section 27b and cylinder section 27c. Flange 27a has an outer diameter that is greater than inner diameter of opening 26c of pivot bearing 26 which has a pair of pivots 26a, 26b. Screw section 27b has an outer diameter that is smaller than inner diameter of pivot bearing 26's opening 26c. Cylinder section 27c which is between flange 27a and screw section 27b has an outer diameter that fits to pivot bearing 26's opening 26c.

Screw section 27b of bearing 27 goes through pivot bearing 26's opening 26c, the inside of an approximate crescent of spring fixing member 25, the inside of an approximate ring of plate spring 24 and coil holder 224's opening 224a. Collar 28 is affixed from the opposite side of flange 27a to be fitting along bearing 27's cylinder section 27c with elevated stage 28a of collar 28 at the bearing 27's flange 27c side. Collar 28 has an inner diameter that fits with cylinder section 27c and an outer diameter that goes through coil holder 224's opening 224a. Shape of collar 28 is similar to that of spring fixing member 25 fixed to plate spring 24 which has an approximate ring shape.

Upper surface 28b of elevated stage 28a makes contact with the flat part of plate spring 24 attached with spring fixing member 25 of an approximate crescent shape. These items are held together by bearing 27's flange 27a and nut 29 to be integrated into head supporting arm unit 221.

As shown in FIG. 23, upper yoke 222 mounted with magnet 11 and lower yoke 223 are fixed to chassis or other member of cabinet (not shown), while voice coil 10 which being a constituent part of head supporting arm unit 221 is positioned in a space formed between magnet 11 and lower yoke 223.

Since plate spring 24 is sandwiched by bearing 27's flange 27a and nut 29, a pair of pivots 26a, 26b of pivot bearing 26 are made to have contact at their summit points with the upper surface (the surface that has no head slider 9) of head supporting arm 8. Thus, head supporting arm 8 is elastically connected with pivot bearing 26 via plate spring 24 and the pair of pivots 26a, 26b.

Head supporting arm 8 receives a downward force at the tab 8a side, viz. a force towards recording medium 4, with the straight line which contains respective contact points P1 and P2 of the pair of pivots 26a and 26b of pivot bearing 26 making contact with the upper surface of head supporting arm 8 as fulcrum; namely, in the direction towards recording medium 4. Namely, head supporting arm 8 can revolve around the line P1-P2, or axis 30 for vertical revolution, in the direction perpendicular to the surface of recording medium 4, as shown in FIG. 24.

Accordingly, a load on head slider 9 is caused by a compression stress in the direction towards recording medium 4, or a reactive force to deformation of plate spring 24 effective to head supporting arm 8 caused by respective contact points P1 and P2 of the pair of pivots 26a and 26b of pivot bearing 26. Thus, as the result of mutual relationship between a force effective to head slider 9 energizing towards recording medium 4 and a levitation force working in the opposite direction, a certain specific gap is provided between head slider 9 mounted with a magnetic head and recording medium 4, and a magnetic disk drive performs the recording and play back operations.

As shown in FIG. 22, axis 30 for vertical revolution is provided so that it contains center 5a of shaft for the horizontal revolution 5 which allows head supporting arm unit 221 to revolve in parallel with the surface of recording medium 4, and perpendicular to center line 8d of head supporting arm 8 in the length direction. It is preferred that the two contact points P1 and P2 are disposed symmetrically with respect to center 5a of shaft for horizontal revolution 5, and the middle point of the line P1-P2 virtually coincides with center 5a of shaft for horizontal revolution 5. By structuring as such, head supporting arm 8 which is a constituent member of head supporting gear 220 can revolve around the line containing P1 and P2, or contact points of pivots 26a and 26b, in the direction perpendicular to the surface of recording medium 4, and the head slider 9 side is energized by a spring force of plate spring 24 towards recording medium 4. The above-described technologies have been disclosed in Japanese Patent Publication No. 3374846 (pages 4, 5, FIG. 4).

In the conventional head supporting gear 220, however, distance d1 (ref. FIG. 22) formed between center 5a of shaft for horizontal revolution 5 and the outer circumference of coil holder 224 in the direction perpendicular to cabinet 226's side surface 226a or a cover (not shown) makes a long distance within an operating range of head supporting gear 220, viz. in a state where the magnetic head is at the innermost of recording region R of recording medium 4, viz. when coil holder 224 is having contact with crush stop 16 (part of the outer circumference of coil holder 224 in this state is designated with two-dot chain line 227 in FIG. 22). This is a point which makes the overall dimensions of a disk drive big-sized.

### SUMMARY OF THE INVENTION

The present invention aims to offer a head supporting gear which solves the above-described drawback; helps realizing a smaller size and provides a stable operation even at resonance frequency, while increasing the resonance frequency a great deal through an enhanced rigidity, and keeping a high flexibility for maintaining a stable load and a superior shock-withstanding property.

It further offers a downsized disk drive which has an improved characteristic about the head positioning control and a high reliability, ensuring a fast transfer of magnetic head to a target track within a significantly reduced access time.

A head supporting gear in the present invention includes a head slider mounted with a signal conversion element, a head supporting arm coupled at one end with the head slider, a voice coil attached to a coil holder which revolves integrated with the head supporting arm at an end opposite to the head slider with respect to the center of horizontal revolution for revolving the head supporting arm in the direction parallel to the surface of recording medium, a pair of pivots which constitutes an axis for the head supporting arm to revolve in the direction perpendicular to the surface of a recording medium, an elastic member which generates a force for energizing the head slider towards the surface of a recording medium around the axis for vertical revolution, a magnet disposed opposed to voice coil in the direction of shaft for horizontal revolution and a yoke disposed opposed to the voice coil in the side that is opposite to the magnet; in which, a first plane which contains the center of gravity in centroid setting portion of a voice coil unit consisting of voice coil and the coil holder and perpendicular to the direction of the center of shaft for horizontal revolution is disposed with a certain distance in the direction of the center of shaft for horizontal revolution from a second plane which contains the axis for vertical revolution and perpendicular to the direction of the center of shaft for horizontal revolution.

### BRIEF DESCRIPTION OF THE DRAWINGS

FIG. 1 is a plan view which shows key portion of a magnetic disk drive in accordance with a first exemplary embodiment of the present invention.

FIG. 2 is a plan view of head supporting arm unit in the first embodiment.

FIG. 3 shows a side view used to describe the main structure of the head supporting gear in the first embodiment.

FIG. 4 is a plan view of voice coil unit in the first embodiment.

FIG. 5 is a plan view which shows voice coil and magnet in the first embodiment.

FIG. 6A is a graph which shows the relation of revolution angle and revolution torque by VCM in the head supporting gear in the first embodiment.

FIG. 6B is a graph which shows the relation of revolution angle and vertical torque by VCM in the head supporting gear in the first embodiment.

FIG. 7 shows the frequency characteristics of a head supporting gear in the first embodiment.

FIG. 8A is a plan view which shows the center of gravity in centroid setting portion of other voice coil unit in the first embodiment.

FIG. 8B is a side view showing the main structure of a head supporting gear which contains the voice coil unit of FIG. 8A.

FIG. 9 shows the frequency characteristics of other head supporting gear in the first embodiment.

FIG. 10 is a graph which shows the relation between location of center of gravity in centroid setting portion of voice coil unit and phase in the frequency characteristics in the first embodiment.

FIG. 11 is a plan view which shows other voice coil unit in the first embodiment.

FIG. 12 is a plan view which shows a head supporting arm and a magnet in accordance with a second exemplary embodiment of the present invention.

FIG. 13 is a side view which shows the structure of a head supporting gear in the second embodiment.

FIG. 14 is a graph which shows the relation of revolution angle and vertical torque by VCM in a head supporting gear in the second embodiment.

FIG. 15 is a plan view which shows a head supporting arm unit and a magnet in a third exemplary embodiment of the present invention.

FIG. 16 is a side view which shows the structure of a head supporting gear in the third embodiment.

FIG. 17 is a plan view of head supporting arm unit used to show the location of center of gravity in centroid setting portion of other voice coil unit in the third embodiment.

FIG. 18 is a plan view which shows a head supporting arm unit and a magnet in a fourth exemplary embodiment of the present invention.

FIG. 19 is a side view which shows the structure of a head supporting gear in the fourth embodiment.

FIG. 20 is a plan view which shows the location of center of gravity in centroid setting portion of other voice coil unit in the fourth embodiment.

FIG. 21 is a side view which shows other example of forming the shaft for vertical revolution in the first through the fourth embodiments of the present invention.

FIG. 22 is a plan view which shows key portion of a conventional magnetic disk drive.

FIG. 23 is a side view which shows the structure of a conventional head supporting gear.

FIG. 24 is a plan view which shows the structure of a conventional head supporting arm unit.

FIG. 25 is an exploded perspective view which shows the structure of a conventional head supporting arm unit.

### REFERENCE MARKS IN THE DRAWINGS

1 Revolution Center

2 Revolution Shaft

3 Rotor Hub

4 Recording Medium

5 Shaft for Horizontal Revolution

5a Center of Shaft

6 Bearing

7, 126, 156, 184, 221 Head Supporting Arm Unit

8, 211 Head Supporting Arm

8a Tab

8b, 26c, 224a Opening

8c Dimple

8d, 10a Center Line

9 Head Slider

10 Voice Coil

11 Magnet

12, 122, 186, 222 Upper Yoke

13, 121, 185, 223 Lower Yoke

14 Ramp

15 Ramp Block

16, 17 Crush Stop

18, 226 Cabinet

18a, 226a Side Surface

21 Gimbals

22, 81, 111, 123, 153, 171, 181, 201, 224 Coil Holder

22a, 111a, 123a, 153a, 171a, 181a, 201a Thickened Part

22b, 43, 83, 227 Two-dot Chain Line

23, 82, 112, 124, 151, 172, 182, 202, 225 Voice Coil Unit

24 Plate Spring (Elastic Member)

25 Spring Fixing Member

26 Pivot Bearing

26a, 26b, 211a, 211b Pivot

27, 212 Bearing Unit

27a, 212a Flange

27b Screw Section

27c Cylinder Section

28 Collar

28a Elevated Stage

28b Upper Surface

29 Nut

30 Axis for Vertical Revolution

41 Chain Line

42, 84, 113, 125, 152, 173, 183, 203 Center of Gravity

50, 90, 120, 150, 180, 220 Head Supporting Gear

51 Boundary

61, 62, 63, 64, 141, 142 Curve

α, θ Angle

d1, d2 Distance

P1, P2, Q1, Q2 Contact Point

R Recording Region

### DETAILED DESCRIPTION OF PREFERRED EMBODIMENTS

Exemplary embodiments of the present invention will be described referring to the drawings, using the case with a magnetic disk drive as examples. In the descriptions, the identical elements will be designated with identical symbols, and description on such element will be eliminated depending on situation.

### First Exemplary Embodiment

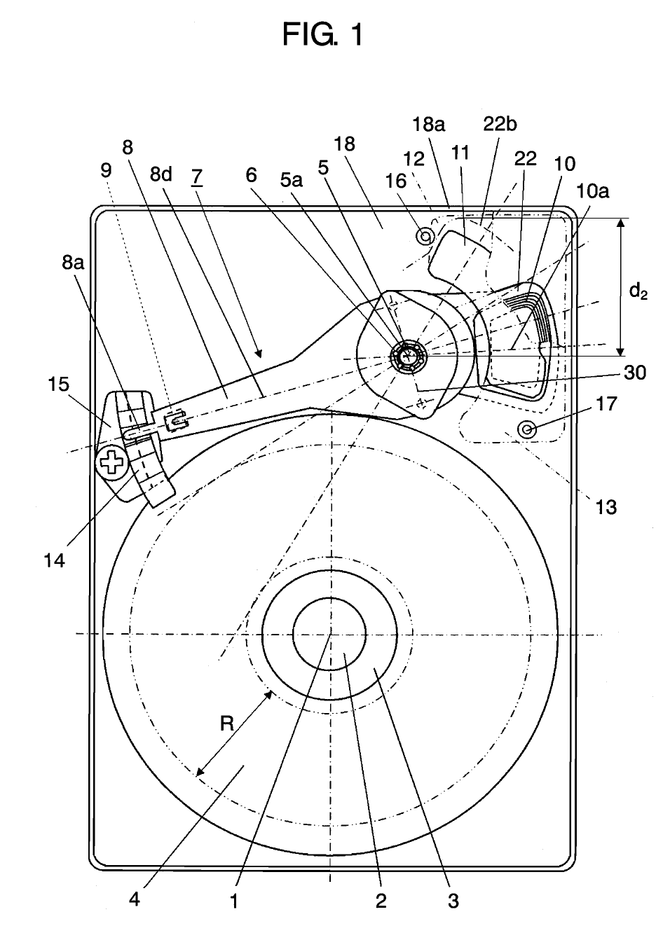

FIG. 1 through FIG. 11 are drawings used to describe head supporting gears in accordance with a first embodiment of the present invention and disk drives which includes the head supporting gear.

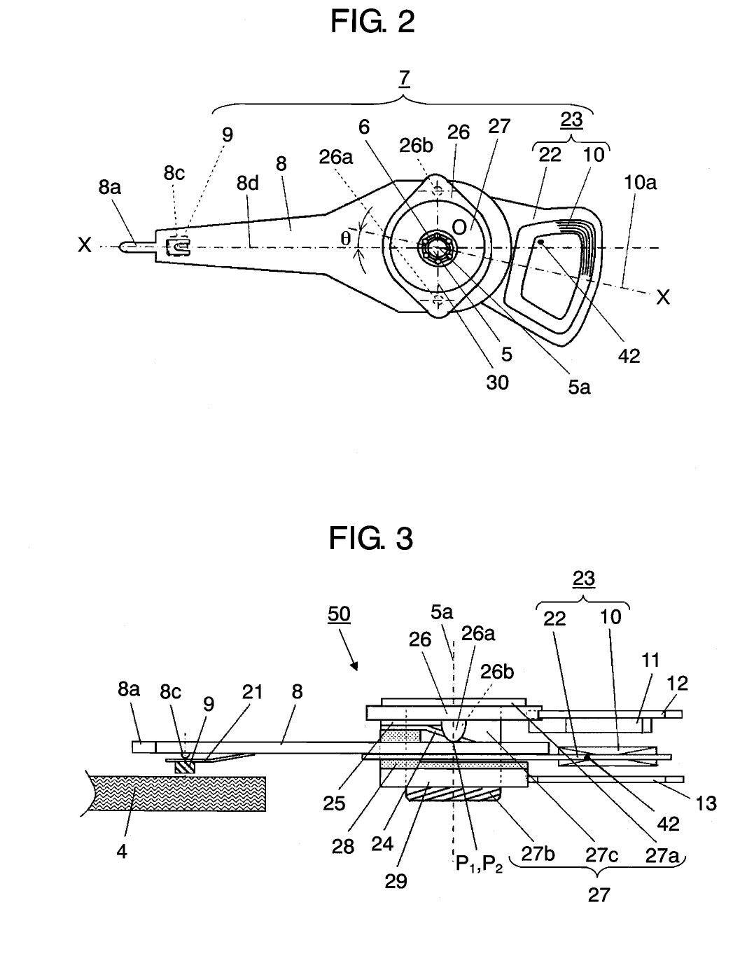

FIG. 1 is a plan view which shows key part of a magnetic disk drive; where, it is shown with the upper lid taken away and the upper yoke partially removed. FIG. 2 shows a plan view of head supporting arm unit. FIG. 3 is a side view which shows key structure of the head supporting gear, sectioned along the straight lines X-O-X of FIG. 2, and unfolded into a straight line. FIG. 2 shows only the head supporting arm unit, while FIG. 3 shows also other elements which do not appear in FIG. 2.

Reference is made to FIG. 1, head supporting arm unit 7, or a swing arm for signal conversion element which can revolve freely in horizontal direction, is supported at center 5a of shaft for horizontal revolution 5 to be mounted on cabinet 18.

As shown in FIG. 3, head supporting gear 50 is formed of head supporting arm unit 7, magnet 11, upper yoke 12 and lower yoke 13. Head supporting arm unit 7 is supported by means of bearing 6 so that it can revolve around shaft for horizontal revolution 5 virtually in parallel with the surface of recording medium 4, with center 5a of shaft for horizontal revolution 5 as the center of revolution. Magnet 11 is disposed above voice coil 10 (the side opposite to recording medium 4 in the direction of center 5a of shaft for horizontal revolution 5) opposing the voice coil, which coil being a constituent part of head supporting arm unit 7. Magnet 11 is attached fixed to upper yoke 12.

A point of difference of magnetic disk drive in the first embodiment as compared with the above-described conventional magnetic disk drive is in the structure of head supporting gear 50. So, detailed description on magnetic disk drive is eliminated.

Head supporting gear 50 in the present first embodiment has been structured so as center line 8d of head supporting arm 8 in the length direction crosses center line 10a of voice coil 10's revolving motion at a certain angle θ. Accordingly, disposition of magnet 11, which being a constituent element of VCM, is different from that of the conventional configuration.

As shown in FIGS. 2 and 3, center line 10a of voice coil 10's revolving motion does not coincide (overlap) with center line 8d (incl. its extension) of head supporting arm 8 in the length direction. Namely, center line 8d of head supporting arm 8 in the length direction crosses center line 10a of voice coil 10's revolving motion at an angle θ clockwise around center 5a. Voice coil unit 23 formed of coil holder 22 and voice coil 10 is fixed to head supporting arm 8 with the angle θ.

The angle θ is determined so as it does not ill-affect the revolving motion of voice coil unit 23, at the same time a cabinet can be downsized.

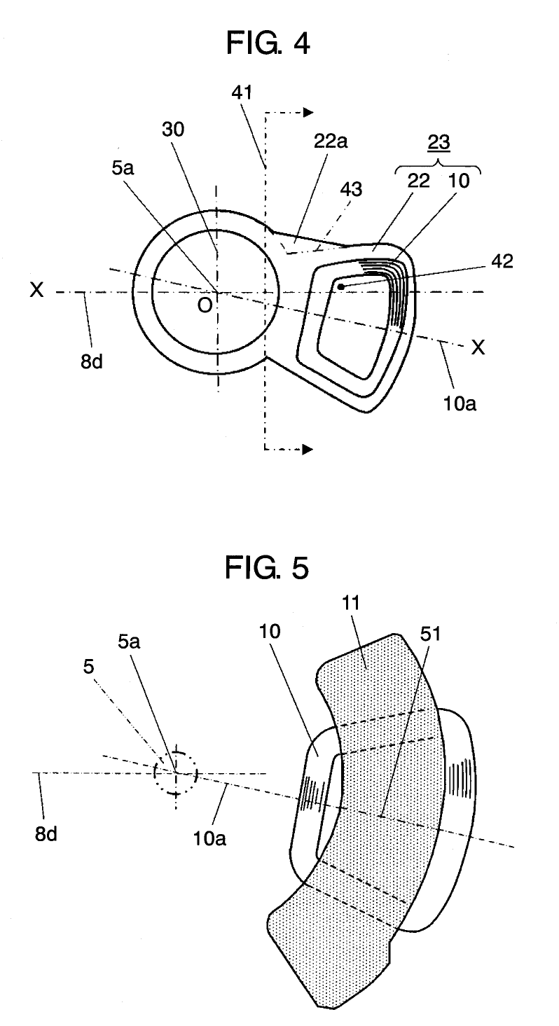

FIG. 4 shows a plan view of voice coil unit. As shown in FIG. 4, voice coil unit 23 is not symmetrical with respect to center line 8d of head supporting arm 8 in the voice coil 10 side of chain line 41 (in a region as indicated by arrow marks of chain line 41). Hereinafter a portion in the region is referred to as centroid setting portion. Coil holder 22 is provided at its one side edge with thickened part 22a in order that center of gravity 42 in centroid setting portion locates on center line 8d of head supporting arm 8; or, the center of gravity is slightly off the center line 8d of head supporting arm 8 in the direction anti-clockwise around center 5a of shaft for horizontal revolution 5 as shown in FIG. 4. Although head supporting arm 8 and voice coil unit 23 have been described as separate items independent to each other, they do not need to be structured as such; instead, they may be integrated into a single unit member.

Head supporting arm unit 7 is held sandwiched, together with pivot bearing 26 consisting of a pair of pivots 26a, 26b, by bearing unit 27 and nut 29 via collar 28. Voice coil unit 23 is attached fixed to head supporting unit 7 with center line 10a making an angle θ with respect to center line 8d of head supporting arm 8. The rest part of the structure remains the same as that of head supporting arm unit 221 described in the conventional technology; so, further description is eliminated.

Load on head slider 9 working towards recording medium 4 is generated in the form of a reactive force to deformation of plate spring 24 caused by respective contact points P1, P2. As the result of mutual relation between the energizing force working on head slider 9 towards recording medium 4 and levitation force working in the opposite direction, head slider 9 floats, and magnetic disk drive performs the recording and play back operations keeping a certain specific gap between head slider 9 mounted with magnetic head and recording medium 4.

A straight line containing contact points P1 and P2, which being the points where pivots 26a and 26b are in contact with the upper surface of head supporting arm 8, is located so as axis 30 for vertical revolution contains center 5a of shaft for horizontal revolution 5 and perpendicular to center line 8d of head supporting arm 8 in the length direction. It is preferred that contact points P1 and P2 are disposed symmetrical with respect to center 5a of shaft for horizontal revolution 5, and the middle point of the straight line P1-P2 virtually coincides with shaft center 5a.

Head supporting arm unit 7 has the above-described configuration. Head supporting arm 8 can be manufactured with a high rigidity material. So, the anti-shock property withstanding a big impact from outside can be enhanced. Furthermore, resonance frequency of head supporting arm can be raised, and the head supporting gear can be revolved at a higher speed for quicker head positioning.

Plate spring 24, an elastic member, is provided not as an integrated part of head supporting arm 8, but it is provided as a separate member. Therefore, such contradictory requirements as increasing the load on head slider 9, lowering the spring constant, and raising the rigidity of structural body can be implemented independently, as the consequence that they are separate constituent elements. Furthermore, since thickness, material, etc. of plate spring 24 can be determined by itself, the strength and the spring constant can be set at desired values respectively. So, the designing of head supporting gear 50 becomes simpler, making the scope of designing freedom remarkably broader. Plate spring 24 and head supporting arm 8 may of course be provided as an integrated structure if it can be so designed without any problem.

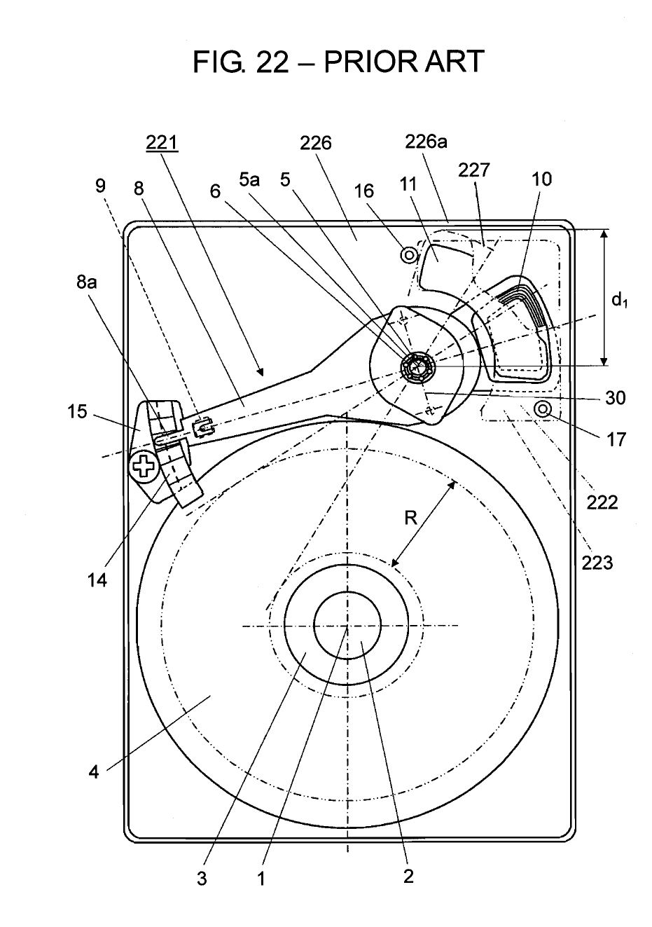

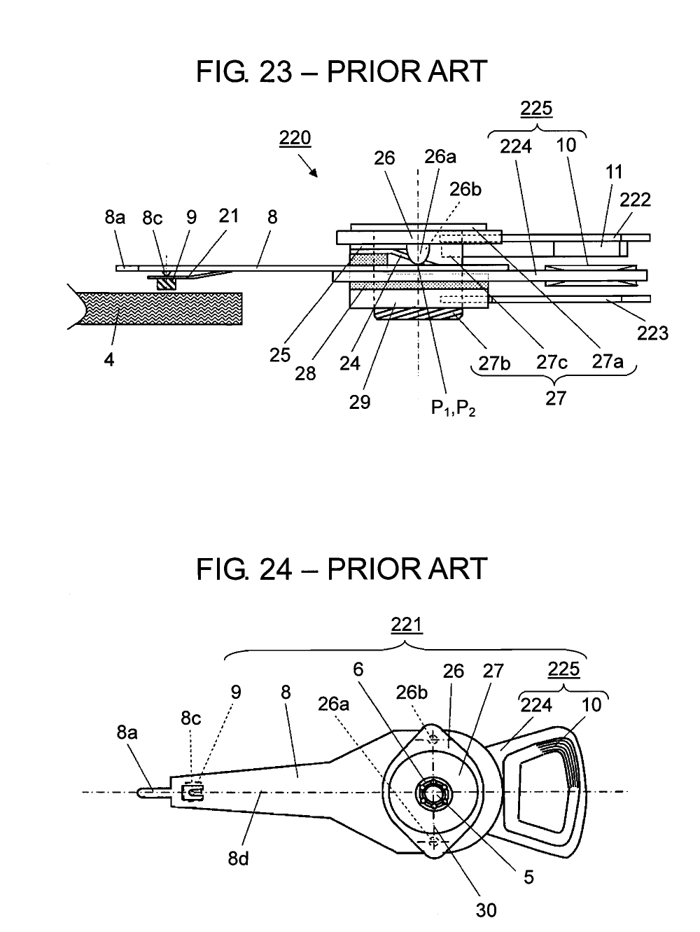

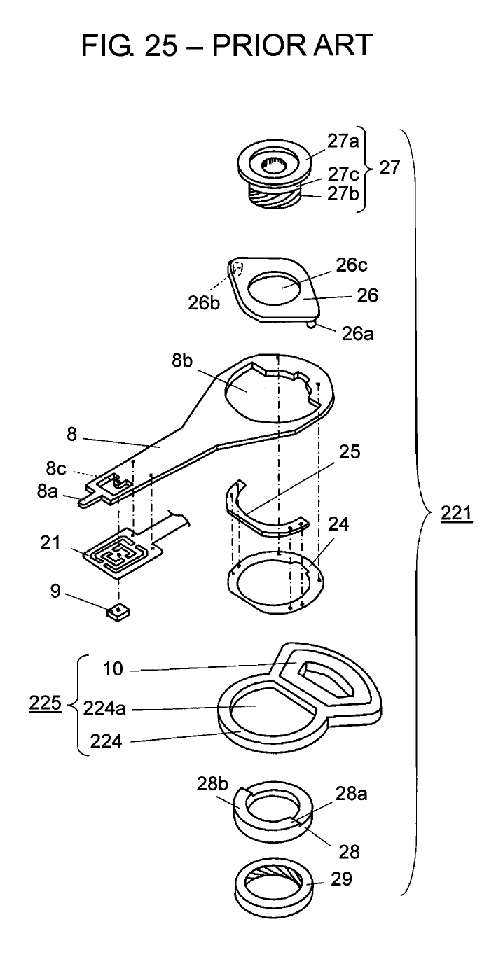

In FIG. 1, location of the outer edge of coil holder 22 in the state where the magnetic head is at the innermost of recording region R of recording medium 4, namely when coil holder 22 is having contact with crush stop 16, is indicated with two-dot chain line 22b. Coil holder 22 in this state is at its closest to cabinet 18's side surface 18a, or a side surface of a cover (not shown). In this state, distance d2 from center 5a of shaft for horizontal revolution 5 to the outer circumferential edge of coil holder 22 in the direction perpendicular to cabinet 18's side surface 18a is shorter than distance d1 (ref. FIG. 22) described earlier in the conventional technology. Accordingly, a magnetic disk drive which incorporates the above-configured head supporting gear 50 can be downsized.

Next, magnet 11 which opposes to voice coil 10 mounted in coil holder 22 is described.

FIG. 5 is a plan view which shows the voice coil and the magnet constituting a VCM, as viewed from the magnet side. As shown in FIG. 5, magnet 11 has been magnetized so that boundary 51 between the pole N (not shown) and the pole S (not shown) coincides with center line 10a of voice coil 10's revolving motion in the state where head supporting arm unit 7's magnetic head (not shown) is at the outermost of recording region R of recording medium 4.

When an electric current is delivered to voice coil 10, head supporting arm unit 7 is revolved by VCM, a magnetic force is generated in accordance with Fleming's rule between voice coil 10 and magnet 11, the revolving direction of head supporting arm unit 7 is determined depending on direction of the current to voice coil 10 and direction of line of magnetic force from magnet 11 disposed opposed to voice coil 10. Magnetic flux proceeds from the pole N of magnet 11 towards lower yoke 13; however, the direction is not necessarily perpendicular to the yoke, but the magnetic flux starts expanding from the pole N and reaches lower yoke 13. From lower yoke 13, the magnetic flux converges towards the pole S. A force effects on voice coil 10 in accordance with Fleming's rule in the direction perpendicular to the magnetic flux. Therefore, voice coil 10 is affected by a vertical torque component, repulsion or attraction, with respect to magnet 11 in the direction of center 5a of shaft for horizontal revolution 5.

When an electric current is delivered to voice coil 10 in the direction for revolving head supporting arm unit 7 towards inner circle of recording medium 4's recording region (loading direction), head supporting arm unit 7 revolves towards the inner circle of recording medium 4's recording medium, and a vertical torque component works to voice coil 10 corresponding to a magnetic force between voice coil 10 and magnet 11. On the other hand, when an electric current is delivered to voice coil 10 in the direction for revolving head supporting arm unit 7 towards the outer circle of recording medium 4's recording region (unloading direction), head supporting arm unit 7 revolves towards the outer circle of recording medium 4's recording region, and a vertical torque component works to voice coil 10 corresponding to a magnetic force between voice coil 10 and magnet 11.

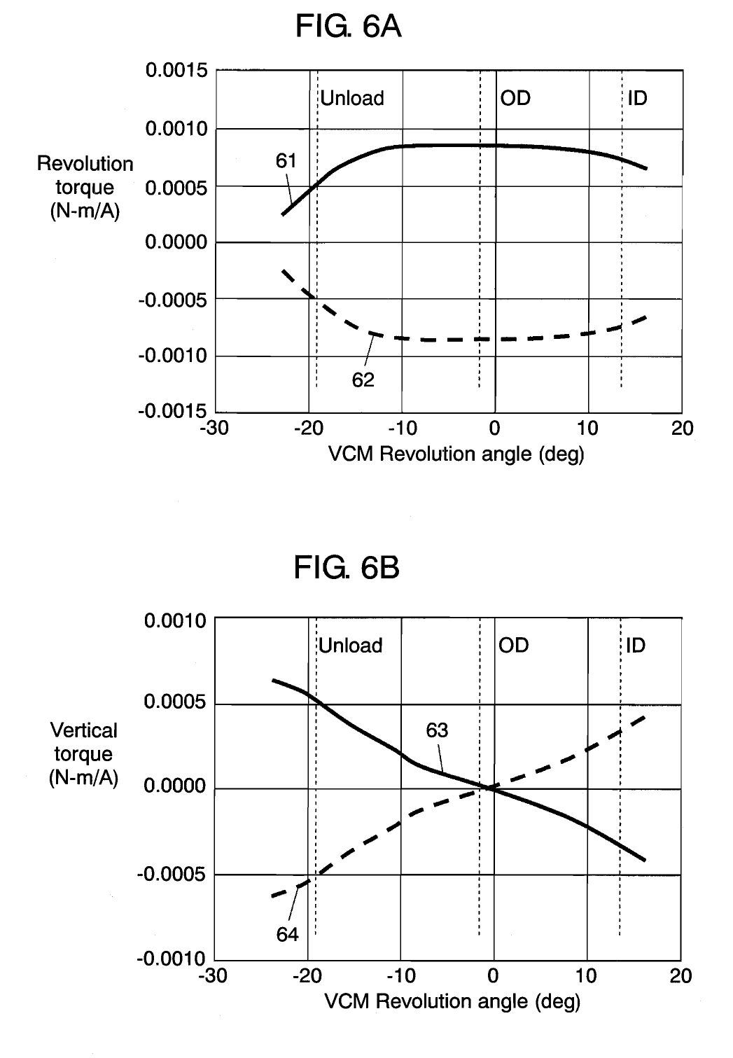

FIG. 6A and FIG. 6B are graphs which show an example of revolving torque component caused to head supporting arm unit 7 by VCM and vertical torque component due to magnet 11 working to voice coil 10, when a certain specific electric current is delivered to voice coil 10. In FIG. 6A and FIG. 6B, the location of head supporting arm 8's center line 8d when the magnetic head is at the outermost circle OD of recording medium 4's recording region is set as the origin of the horizontal axis; direction from the location towards the center of recording medium 4 (the innermost ID side) is treated as the +plus side, while that towards unloading side (unloading location Unload side) as the −minus side, designated in terms of the revolution angle of VCM.

In FIG. 6A, vertical axis represents revolving torque component effective to head supporting gear 50; the one for revolving in loading direction is given at the +plus side, whereas the one for revolving in unloading direction is given at the −minus side. As to vertical torque component between voice coil 10 and magnet 11 shown in vertical axis of FIG. 6B, the repelling one is given at the +plus side, whereas the attracting one is at the −minus side.

Accordingly, curve 61 in FIG. 6A shown with solid line represents revolving torque component during revolving in the loading direction, while curve 62 shown with dotted line represents that during revolving in the unloading direction. Curve 63 in FIG. 6B shown with solid line represents vertical torque component due to magnetic force between voice coil 10 and magnet 11 during revolving in the loading direction, while curve 64 shown with dotted line represents that during revolving in the unloading direction.

As the result, when an electric current is delivered to voice coil 10 for revolving head supporting gear 50, voice coil unit 23 is bent, although for a very small amount, by vertical torque component of magnetic force generated between voice coil 10 and magnet 11, with axis 30 for vertical revolution of head supporting arm unit 7 as fulcrum. This causes a bending resonance mode with voice coil unit 23.

In the present first embodiment, the center of gravity 42 in centroid setting portion of voice coil unit 23 (a portion of voice coil unit 23 that is not symmetrical with respect to center line 8d of head supporting arm 8 in the length direction) locates in the recording medium 4 side in the direction of center 5a of shaft for horizontal direction 5 with respect to a plane which contains axis 30 for vertical revolution and perpendicular to shaft for horizontal revolution 5.

Namely, a first horizontal plane which contains center of gravity 42 in centroid setting portion of voice coil unit 23 consisting of voice coil 10 and coil holder 22 and perpendicular to the direction of center 5a of shaft for horizontal revolution 5 is disposed with a certain distance in the direction of center 5a of shaft 5 from a second plane which contains the axis for vertical revolution and perpendicular to the direction of center 5a of shaft for horizontal revolution 5.

The location of center of gravity 42 subtly shifts in relation to head supporting arm unit 7's axis 30 for vertical revolution, and head supporting arm unit 7 receives a revolving force around shaft center 5a. This gives influence on the resonance frequency of head supporting gear 50's frequency characteristics.

Next, results of a study about relationship between location of center of gravity in centroid setting portion of voice coil unit 23 and frequency characteristics of head supporting gear 50 are described in the following.

Voice coil unit 23 illustrated in FIG. 4 with solid line is provided with thickened portion 22a at an edge in the anti-clockwise side of coil holder 22. As the result, the location of center of gravity in centroid setting portion of voice coil unit 23 shifts anti-clockwise around center 5a of shaft for horizontal revolution 5 to be slightly off the center line 8d of head supporting arm 8 in the length direction.

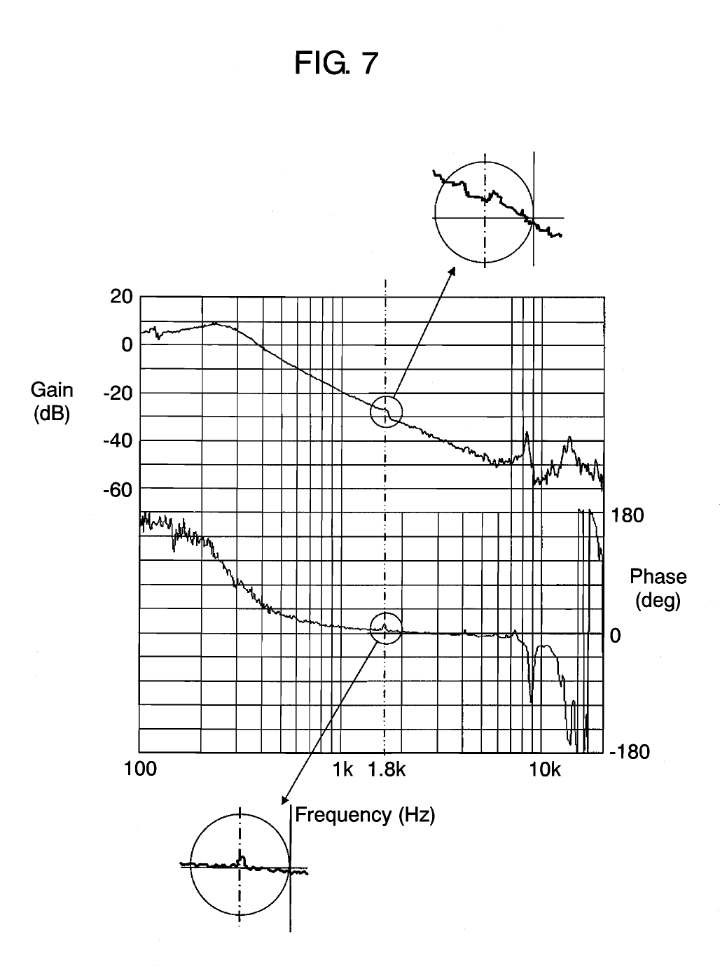

FIG. 7 shows frequency characteristics of head supporting gear 50 having the above voice coil unit 23.

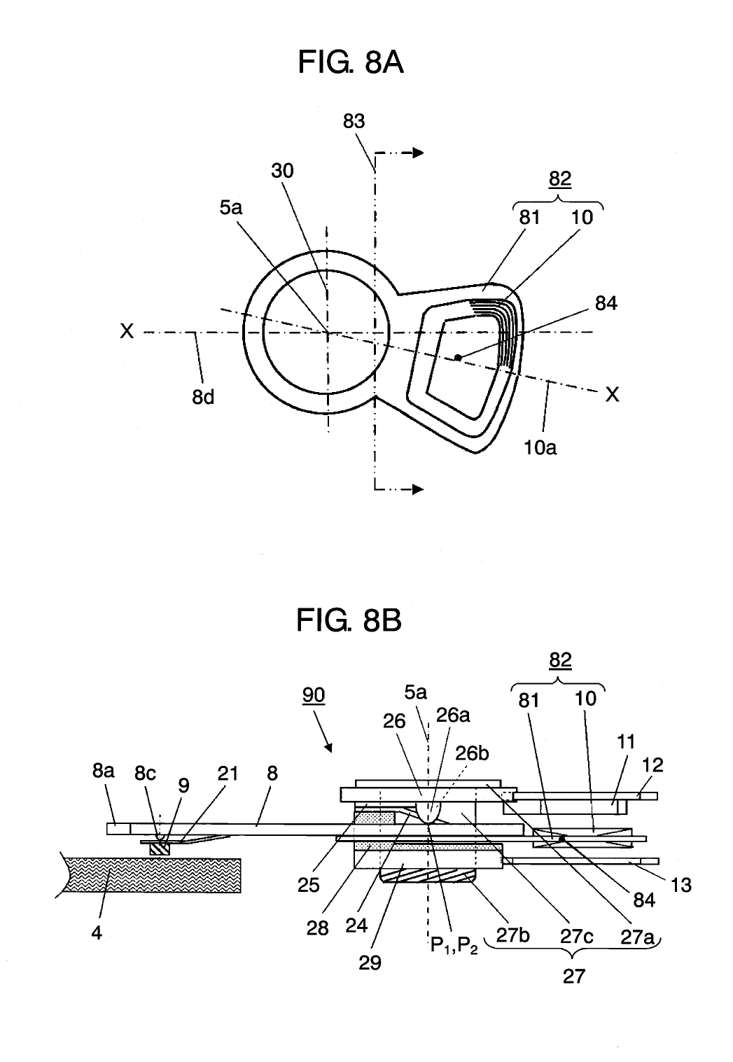

FIG. 8A is a plan view which shows the center of gravity in centroid setting portion of other voice coil unit in the present embodiment. FIG. 8B is a side view which shows the key structure of a head supporting gear incorporating the voice coil unit of FIG. 8A.

As shown in FIGS. 8A and 8B, the center of gravity 84 in centroid setting portion of voice coil unit 82 of head supporting gear 90, viz. a portion which is in the voice coil 10 side with respect to two-dot chain line 83, locates at the vicinity of center line 10a of voice coil 10, which means that it is away from center line 8d of head supporting arm 8 in the length direction clockwise around center 5a of shaft for horizontal revolution 5. Voice coil unit 82 is consisting of coil holder 81 and voice coil 10.

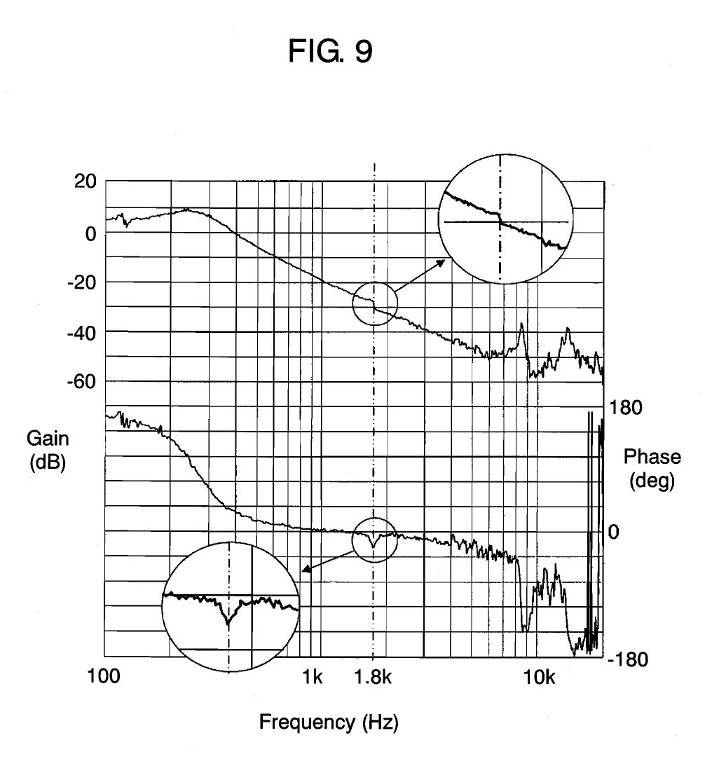

FIG. 9 shows frequency characteristics of the above-configured head supporting gear 90. The structure of this case corresponds to the case of voice coil unit 23 illustrated with two-dot chain line 43 in FIG. 4; which voice coil unit 23 consisting of coil holder 22 and voice coil 10 being symmetrical with respect to center line 10a of voice coil 10's revolving motion.

According to the study results, each of the above head supporting gears 50 and 90 has resonance point at a frequency approximately 1.8 kHz. As to the respective phases at the resonance point, head supporting gear 50 exhibited an advance phase, viz. a +(plus) phase, and the value of advance was very small, whereas head supporting gear 90 exhibited a delay phase, viz. a −(minus) phase, and the value of delay was great.

That the value of phase delay at resonance frequency is great means a head supporting gear harbors instable element at resonance frequency. Whereas, that it exhibits an advance phase at resonance frequency means the frequency characteristics of a head supporting gear are stable at resonance frequency.

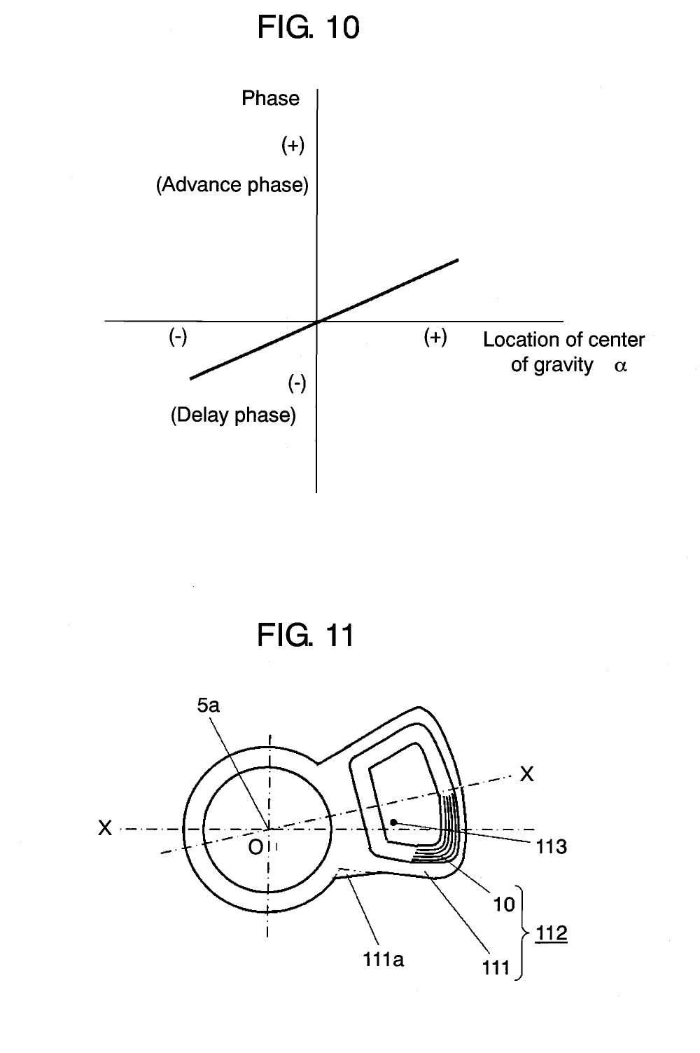

FIG. 10 shows the results of study about relationship of the angle α and the phase at resonance frequency of head supporting gear 50; where, angle α is an angle formed between a straight line which contains center of gravity 42 in centroid setting portion of voice coil unit 23 and center 5a of shaft for horizontal revolution 5, and center line 8d of head supporting arm 8 in the voice coil unit 23 side. In FIG. 10, the horizontal axis represents an angle α; anti-clockwise angle around shaft center 5a is treated as a +(plus), whereas that of clockwise as a −(minus). In the vertical axis, an advance phase is treated as a +(plus), whereas a delay phase as a −(minus).

Based on the above observations, it is preferred to locate center of gravity 42 in centroid setting portion of voice coil unit 23, which is affected by vertical torque component of magnetic force, on the center line 8d of head supporting arm 8 in the length direction, or at a place in the direction anti-clockwise around center 5a of shaft for horizontal revolution 5 with respect to center line 8d of head supporting arm 8. By so locating, an influence of a magnetic force between voice coil 10 and magnet 11 on the frequency characteristics of head supporting gear 50 can be suppressed to be small, and the phase characteristic of head supporting gear 50's frequency characteristics can be made be advance-phased. As the results, a head supporting gear can realize a stable location servo characteristic, and make a seek operation stable for more accurate head positioning.

For the purpose of making head supporting gear 50 compact and light in weight, an effort has to be made to bring the center of gravity in centroid setting portion of voice coil unit 23 at a place which is at least in the direction anti-clockwise around center 5a of shaft for horizontal revolution 5 with respect to center line 8d of head supporting arm 8, taking dispersions in the materials forming voice coil unit 23 into consideration; and then, thickened part 22a can suppressed to be a minimum.

Furthermore, it is preferred that in head supporting arm unit 7 of head supporting gear 50 the center of gravity of total mass of those members revolving around axis 30 for vertical revolution, viz. head supporting arm 8, voice coil unit 23, such portion of plate spring 24 that is having contact with head supporting arm 8, gimbals 21 and head slider 9, locates virtually in a plane which contains a straight line connecting contact points P1 and P2, which are the points of contact made by a pair of pivots 26a and 26b of pivot bearing 26 on the upper surface of head supporting arm 8, viz. axis 30 for vertical revolution (including the extended line) and center 5a of shaft for horizontal revolution 5. By so disposing it, a possible revolving motion of head supporting arm 8 caused by an external impact given in the direction of center 5a of horizontal revolution shaft 5 can be suppressed; and a damage on recording medium 4 due to head slider 9 hitting the surface is prevented. Thus, a head supporting gear demonstrates a very high anti-shock capability.

Still further, in order to have the center of gravity of those members revolving around axis 30 for vertical revolution locate virtually in the plane which contains axis 30 for vertical revolution and center 5a of shaft for horizontal revolution 5, a balancer may be used in addition. Anyway, the location of center of gravity 42 in centroid setting portion of the above-described voice coil unit 23 needs to be locating in a place at least in the direction anti-clockwise around center 5a of horizontal revolution shaft 5 with respect to center line 8d of head supporting arm 8 in the length direction.

Head supporting gear 50 described in the above has been structured so that voice coil unit 23 is disposed in a manner where the center line 10a of voice coil 10's revolving motion, which center line containing center 5a of shaft for horizontal revolution 5, crosses at an angle θ clockwise around center 5a with the center line 8d of head supporting arm 8 in the length direction. The present invention, however, is not limited to the above configuration.

FIG. 11 is a plan view which shows other voice coil unit in the present first embodiment. A head supporting gear in which the center line 10a of voice coil 10's revolving motion makes an angle θ anti-clockwise around shaft center 5a with the center line 8d of head supporting arm 8 also exhibits the same effects. Namely, the center of gravity in centroid setting portion of a voice coil unit has to be locating in a place at least in the direction anti-clockwise around center 5a of shaft for horizontal revolution 5 with respect to center line 8d of head supporting arm 8. Anyway, it is preferred in a head supporting gear of the above configuration that the center of gravity 113 in centroid setting portion of voice coil unit 112 is brought to a place at least in the direction anti-clockwise around center 5a of shaft for horizontal revolution 5 with respect to center line 8d of head supporting arm 8; by providing thickened part 111a at a side edge of coil holder 111 which is closer to center line 8d of head supporting arm 8 as illustrated in FIG. 11.

As described in the above, a head supporting arm of head supporting gear in the present first embodiment can be manufactured with a material of high rigidity. So, it not only enhances the shock-withstanding capability against a big impact from outside, but it can also raise resonance frequency of a head supporting arm. As the result, a head supporting gear can be revolved at a high speed for head positioning.

Furthermore, since a plate spring which is an elastic member is provide as a separate member who is independent of the head supporting arm, a load to head slider can be determined at a desired value easily. This makes a range of designing freedom broader.

Still further, a disk drive which contains a head supporting gear whose center line of voice coil crosses the center line of head supporting arm at a certain angle can reduce its overall size. Further, it can advance the phase at resonance frequency of head supporting gear; so, oscillation or the like instable characteristic does not appear at resonance frequency. Thus a head supporting gear realizes an improved location servo characteristic, stabilizes seek operation for more accurate head positioning.

A magnetic disk drive incorporating the above-configured head supporting gear can realize a downsizing, an enhanced shock-withstanding capability, a faster access speed, and head positioning with an improved accuracy.

### Second Exemplary Embodiment

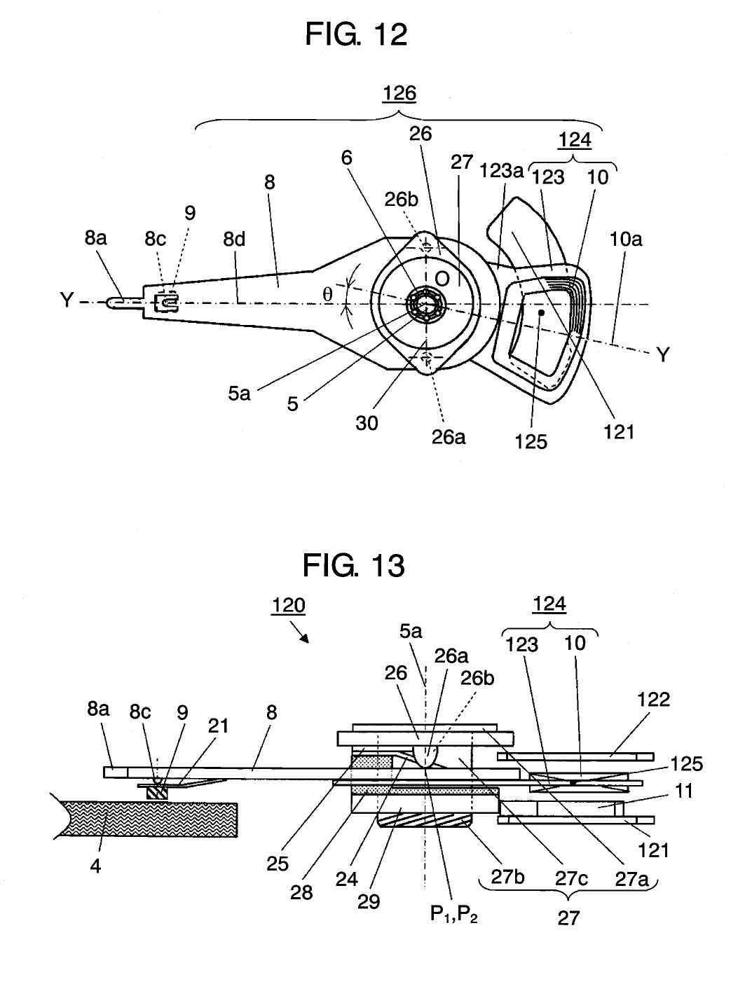

FIG. 12 through FIG. 14 are for describing a head supporting gear in accordance with a second exemplary embodiment of the present invention.

Structure of head supporting gear 120 in the second embodiment is different from that of head supporting gear 50 of the first embodiment in the location of magnet 11 which opposes to voice coil 10. The rest part of the structure remains the same, so detailed description on which part is eliminated.

The main points of difference as compared with head supporting gear 50 of the first embodiment are described below referring to the drawings.

FIG. 12 is a plan view which shows the head supporting arm unit and the magnet. FIG. 13 is a side view which shows the head supporting gear sectioned along the straight lines Y-O-Y of FIG. 12, and unfolded into a straight line. FIG. 12 shows the head supporting arm unit only, while FIG. 13 shows also other elements which do not appear in FIG. 12.

As shown in FIGS. 12 and 13, magnet 11 which is a constituent member of VCM in head supporting gear 120 is attached fixed to lower yoke 121 at the recording medium 4 side with respect to voice coil 10. Upper yoke 122 is disposed so as it opposes to lower yoke 121. Location of center of gravity 125 in centroid setting portion of voice coil unit 124 consisting of coil holder 123 and voice coil 10 is in the direction clockwise around center 5a of shaft for horizontal revolution 5 with respect to center line 8d of head supporting arm 8, not much away from the center line 8d of head supporting arm 8. Coil holder 123 is provided at one side edge with thickened part 123a, in order to produce the above-described structure. These are the points of difference from head supporting gear 50 of the first embodiment.

It is not essential to provide thickened portion 123a at one side edge of coil holder 123; but voice coil unit 124 may be provided to be symmetrical with respect to center line 10a of voice coil 10. In the latter case, the location of center of gravity 125 in centroid setting portion of voice coil unit 124 naturally shifts around center 5a of shaft for horizontal revolution 5 to a place in the direction clockwise with respect to center line 8d of head supporting arm 8.

In the same manner as in the first embodiment, magnet 11 is magnetized so that the boundary between the pole N and the pole S coincides with center line 10a of voice coil 10's revolving motion in the state where magnetic head is at the outermost of recording region of recording medium 4.

When an electric current is delivered to voice coil 10, head supporting gear 120 is revolved by VCM. At the same time, a magnetic force is generated between voice coil 10 and magnet 11 in accordance with Fleming's rule; revolving direction of the head supporting gear and direction of vertical torque component effective to voice coil 10 depend on direction of the electric current delivered to voice coil 10 and direction of magnetic flux of magnet 11 opposing to voice coil 10. These points also remain the same as the case in the first embodiment.

Direction of vertical component of magnetic force at revolution in loading direction, or in unloading direction, is reversed to that in the first embodiment. Namely, when head supporting gear 120 is revolved towards inner circle of recording medium 4's recording region, the direction of vertical torque component working between voice coil 10 and magnet 11 turns out to be opposite to that at the revolution in loading direction in the first embodiment. On the other hand, when an electric current is delivered to voice coil 10 for revolution towards unloading direction, the direction of vertical torque component working between voice coil 10 and magnet 11 turns out to be opposite to that at the revolution in loading direction in the first embodiment.

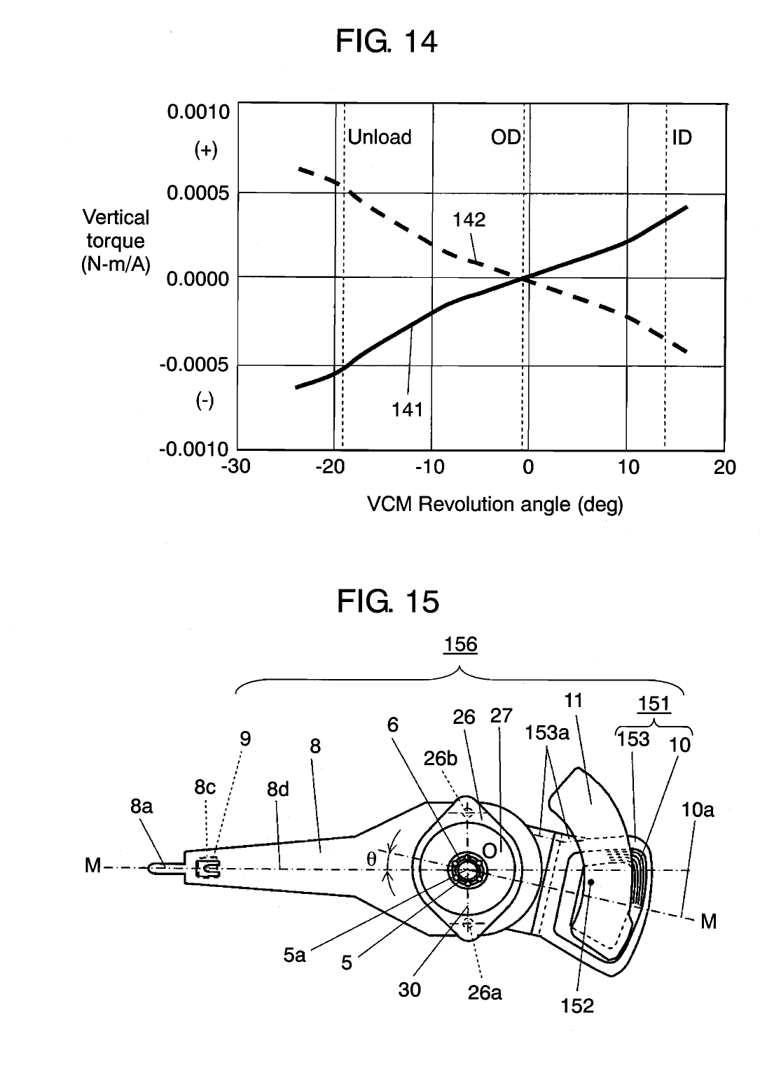

FIG. 14 is a graph which shows a relationship between the angle of revolution of head supporting gear and the vertical torque caused by VCM. Revolution torque component effective to head supporting gear 120 caused by VCM when a certain electric current is applied to voice coil 10 remains the same as that shown in FIG. 6A, the first embodiment. However, the vertical torque component between magnet 11 and voice coil 10 at that occasion turns out to be opposite to the situation shown in FIG. 6B of the first embodiment. Solid line curve 141 in FIG. 14 represents vertical torque component at the loading direction, while dotted line curve 142 represents the vertical torque component at the unloading direction.

So, when an electric current is delivered to voice coil 10 for revolving head supporting gear 120, a bending resonance mode is generated with voice coil unit 124, like in the case of the first embodiment, by a magnetic force between voice coil 10 and magnet 11, with axis 30 for vertical revolution of head supporting gear 120 as fulcrum.

Meanwhile, location of center of gravity 125 in centroid setting portion of voice coil unit 124 is at the recording medium 4 side in the direction of center 5a of shaft for horizontal revolution 5 with respect to a plane which contains axis 30 for vertical revolution and perpendicular to shaft for horizontal revolution 5, and with a certain distance in the direction of center 5a of shaft for horizontal revolution 5 with respect to axis 30 for vertical revolution which acts as fulcrum when voice coil unit 124 is bent by a magnetic force.

Namely, a first plane which contains center of gravity 125 in centroid setting portion of voice coil unit 124 consisting of voice coil 10 and coil holder 123 and perpendicular to the direction of center 5a of shaft for horizontal revolution 5 is disposed with a certain distance in the direction of center 5a of shaft for horizontal revolution 5 from a second plane which contains axis 30 for vertical revolution and perpendicular to the direction of center 5a of shaft for horizontal revolution 5.

So, when voice coil unit 124 is bent by a magnetic force between voice coil 10 and magnet 11, the location of center of gravity 125 in centroid setting portion of voice coil unit 124 subtly shifts in a plane perpendicular to center 5a of shaft for horizontal revolution 5, generating a force for revolving head supporting arm unit 126. Therefore, the vertical component of magnetic force generated between voice coil 10 and magnet 11 gives influence to frequency characteristics of head supporting gear 120, in the same manner as in the case of the first embodiment.

Therefore, relationship between the location of center of gravity in centroid setting portion of voice coil unit 124 of head supporting gear 120 and the phase characteristic of head supporting gear 120 can be made to be an advance phase, among other frequency characteristics, like in the case of the first embodiment, by placing the center of gravity on the center line 8d of head supporting arm 8, or at a place in the direction clockwise around center 5a of shaft for horizontal revolution 5 with respect to center line 8d of head supporting arm 8. By so doing, head supporting gear 120 can realize an improved stability in location servo characteristic, bringing about more accurate head positioning.

In the case of a head supporting gear where center line 10a of voice coil 10's revolving motion crosses center line 8d of head supporting arm 8 with an angle θ anti-clockwise around shaft center 5a, a thickened part is provided in the same manner as in the first embodiment at a side edge of coil holder which is closer to center line 8d of head supporting arm 8; namely, at a side edge in the direction clockwise around center 5a of shaft for horizontal revolution 5. By so doing, center of gravity 125 in centroid setting portion of voice coil unit 124 can be made to be locating at least in the direction clockwise around center 5a of shaft for horizontal revolution 5 with respect to center line 8d of head supporting arm 8.

As described in the above, the present second embodiment also provides the same advantages as those of the first embodiment. A disk drive which incorporates head supporting gear 120 can reduce the overall size. Furthermore, since it can produce an advance phase at resonance frequency of head supporting gear 120, oscillation or the like instable characteristic does not appear at resonance frequency. Head supporting gear 120 can realize a stable location servo characteristic and a stabilized seek operation for head positioning at a significantly improved accuracy.

A magnetic disk drive incorporating the above-configured head supporting gear 120 can reduce the overall size, like in the first embodiment. Furthermore, the magnetic disk drive offers a superior shock-withstanding capability, a higher access speed and more accurate head positioning.

### Third Exemplary Embodiment

FIG. 15 through FIG. 17 are for describing a head supporting gear in accordance with a third exemplary embodiment of the present invention.

Structure of head supporting gear 150 in the third embodiment is different from that of head supporting gear 50 of the first embodiment in the position of magnet 11 which opposes to voice coil 10. The rest part of structure remains the same, so detailed description on which part is eliminated.

In the following, main points of difference of head supporting gear 150 in third embodiment as compared with head supporting gear 50 of the first embodiment are described referring to the drawings.

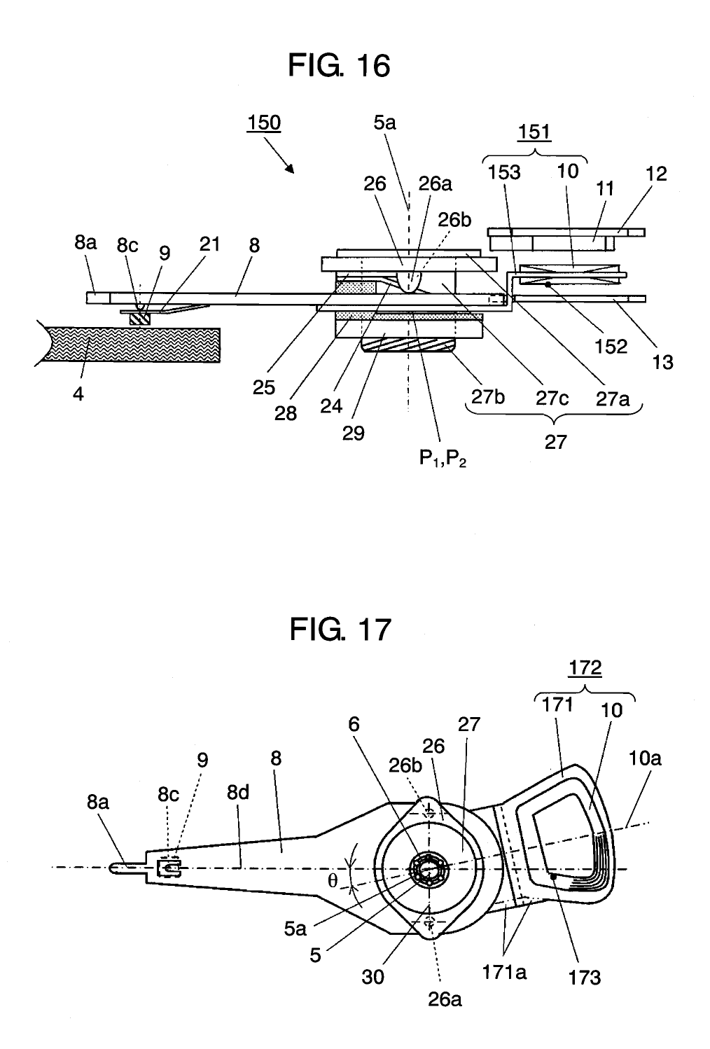

FIG. 15 is a plan view which shows the head supporting arm unit and the magnet. FIG. 16 is a side view which shows the head supporting gear sectioned along M-O-M lines of FIG. 15, and unfolded into a straight line. FIG. 15 shows only the head supporting arm unit and the magnet, while FIG. 16 shows also other elements which do not appear in FIG. 15.

As shown in FIG. 15 and FIG. 16, magnet 11 which is a constituent member of VCM in head supporting gear 150 is attached fixed to upper yoke 12, and disposed at the side opposite to recording medium 4 with respect to voice coil 10. Coil holder 153 is provided at one side edge with thickened part 153a, in order that center of gravity 152 in centroid setting portion of voice coil unit 151 formed of coil holder 153 and voice coil 10 locates at a place in the direction clockwise around center 5a of shaft for horizontal revolution 5 with respect to center line 8d of head supporting arm 8, not much away from the center line 8d. These are the points of difference as compared with head supporting gear 50 of the first embodiment.

It is not essential to provide thickened portion 153a at one side edge of coil holder 153; voice coil unit 151 may be symmetrical with respect to center line 10a of voice coil 10. In the latter case, the center of gravity 152 in centroid setting portion of voice coil unit 151 naturally shifts to a place in the direction clockwise around center 5a of shaft for horizontal revolution 5 with respect to center line 8d of head supporting arm 8.

In the same manner as in the first embodiment, magnet 11 is magnetized so that the boundary between the pole N and the pole S coincides with center line 10a of voice coil 10's revolving motion in the state where magnetic head is at the outermost of recording region of recording medium 4.

When an electric current is delivered to voice coil 10, head supporting gear 150 is revolved by VCM, and a magnetic force is generated in accordance with Fleming's rule between voice coil 10 and magnet 11. The revolving direction of head supporting gear 150 and direction of vertical torque component effective to voice coil 10 are determined depending on direction of the current delivered to voice coil 10 and direction of magnetic flux of magnet 11 opposing to voice coil 10. These are also the same as in the case of the first embodiment.

Direction of vertical component of magnetic force at revolution in loading direction, or in unloading direction, becomes opposite to that in the case of the first embodiment. Namely, when head supporting gear 150 is revolved towards inner circle of recording medium 4's recording region, vertical torque component works between voice coil 10 and magnet 11 in the direction opposite to that at revolution in loading direction in the first embodiment. On the other hand, when an electric current is delivered to voice coil 10 for the revolution in unloading direction, vertical torque component works between voice coil 10 and magnet 11 in the direction opposite to that at revolution in loading direction in the first embodiment.

Revolution torque component with head supporting gear 150 generated by VCM when a certain specific current is delivered to voice coil 10 remains the same as the case of the first embodiment shown in FIG. 6A. Vertical torque component between magnet 11 and voice coil 10 in this situation is the same as that in the case of the first embodiment shown in FIG. 6B.

Therefore, when an electric current is delivered to voice coil 10 for revolving head supporting gear 150, a magnetic force between voice coil 10 and magnet 11 causes a bending resonance mode with voice coil unit 151, in the same manner as in the first embodiment, with axis 30 for vertical revolution acting as fulcrum.

Meanwhile, center of gravity 152 in centroid setting portion of voice coil unit 151 locates at the side that is opposite to recording medium 4 in the direction of center 5a of shaft for horizontal revolution 5 with respect to a plane which contains axis 30 for vertical revolution and perpendicular to shaft for horizontal revolution 5, with a certain distance in the direction of center 5a of shaft for horizontal revolution 5 from axis 30 for vertical revolution which acts as fulcrum when voice coil unit 151 is bent by magnetic force.

Namely, a first horizontal plane which contains center of gravity 152 in centroid setting portion of voice coil unit 151 consisting of voice coil 10 and coil holder 153 and perpendicular to center 5a of shaft for horizontal revolution 5 is disposed with a certain distance in the direction of center 5a of shaft for horizontal revolution 5 from a second plane which contains axis 30 for vertical revolution and perpendicular to center 5a of shaft for horizontal revolution 5.

Therefore, the location of center of gravity 152 in centroid setting portion of voice coil unit 151 subtly shifts in a plane perpendicular to center 5a of shaft for horizontal revolution 5 when voice coil unit 151 is bent by a magnetic force between voice coil 10 and magnet 11, which brings about a force for revolving head supporting arm unit 156. As the result, vertical component of a magnetic force between voice coil 10 and magnet 11 gives influence to frequency characteristics of head supporting gear 150, in the same manner as in the first embodiment.

Relationship between the location of center of gravity 152 in centroid setting portion of voice coil unit 151 of head supporting gear 150 and the frequency characteristics of head supporting gear 150 can be made to be an advance phase, among other frequency characteristics of head supporting gear 150, by placing the center of gravity on the center line 8d of head supporting arm 8, or at a place in the direction clockwise around center 5a of shaft for horizontal revolution 5 with respect to center line 8d of head supporting arm 8, like in the case of the first embodiment. By so doing, head supporting gear 150 can realize an improved stability in location servo characteristic, and an improved accuracy of head positioning.

FIG. 17 is a plan view of other voice coil unit of head supporting arm unit, which is used to describe the location of center of gravity in centroid setting portion of voice coil unit. In the case of FIG. 17, where center line 10a of voice coil 10's revolving motion forms an angle θ anti-clockwise around shaft center 5a to center line 8d of head supporting arm 8, thickened part 171a is provided in the same manner as in the first embodiment at a side edge of coil holder 171 which is closer to center line 8d of head supporting arm 8, viz. at a side edge in the direction clockwise around center 5a of shaft for horizontal revolution 5. By so doing, center of gravity 173 in centroid setting portion of voice coil unit 172 can be located at a place at least in the direction clockwise around center 5a of shaft for horizontal revolution 5 with respect to center line 8d of head supporting arm 8.

As described in the above, the present third embodiment also provides the same advantages as those of the first and the second embodiments. A disk drive which incorporates head supporting gear 150 can reduce the overall size. Furthermore, since it can realize an advance phase at resonance frequency of head supporting gear 150, oscillation or the like instable characteristic does not appear at resonance frequency. Head supporting gear 150 realizes a stable location servo characteristic and a stabilized seek operation for significantly improved accuracy in head positioning.

A magnetic disk drive which incorporates the above-configured head supporting gear 150 can reduce the overall size, like in the first and the second embodiments. The magnetic disk drive further demonstrates an enhanced shock-withstanding capability, a higher access speed and more accurate head positioning.

### Fourth Exemplary Embodiment

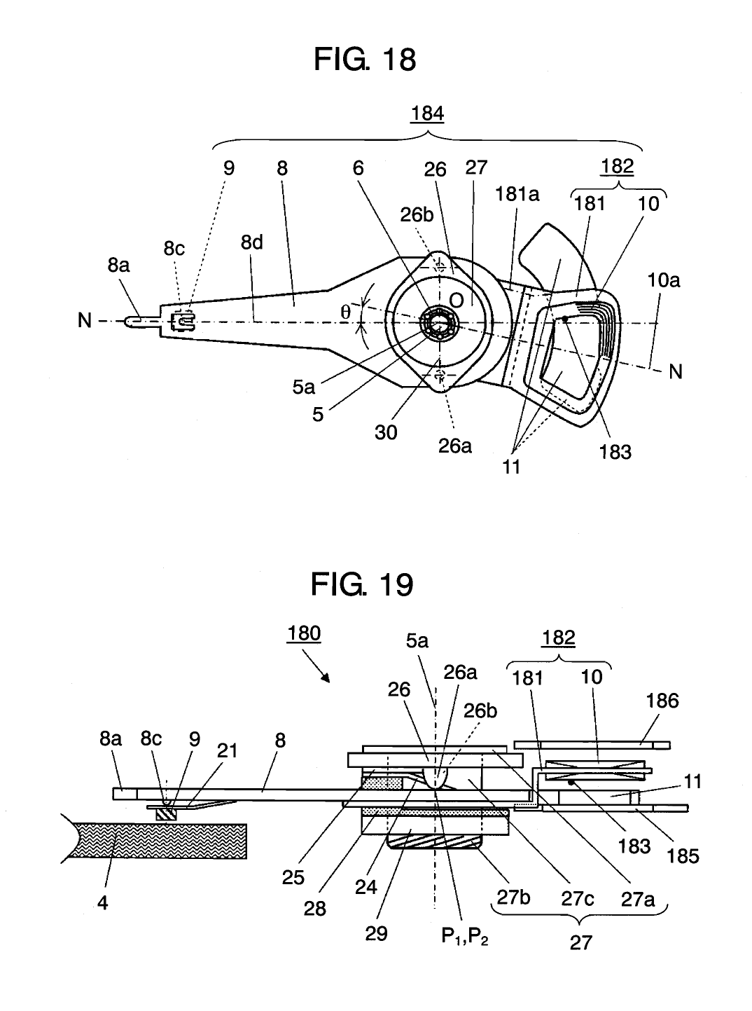

FIG. 18 through FIG. 20 are for describing a head supporting gear in accordance with a fourth embodiment of the present invention.

Structure of head supporting gear 180 in the fourth embodiment is different from that of head supporting gear 150 of the third embodiment in the location of magnet 11 opposing to voice coil 10. The rest part of structure remains the same, so detailed description on which part is eliminated.

Main points of difference in head supporting gear 180 of the fourth embodiment as compared with head supporting gear 50 of the first embodiment and head supporting gear 150 of the third embodiment are described below referring to the drawings.

FIG. 18 is a plan view showing the head supporting arm unit and the magnet. FIG. 19 is a side view which shows the head supporting gear sectioned along the straight lines N-O-N of FIG. 18, and unfolded into a straight line. FIG. 18 shows the head supporting arm unit and the magnet only, while FIG. 19 shows also other elements which do not appear in FIG. 18.

As shown in FIG. 18 and FIG. 19, magnet 11 which is a constituent member of VCM in head supporting gear 180 is attached fixed to lower yoke 185, at the recording medium 4 side of voice coil 10. Upper yoke 186 is disposed opposing to lower yoke 185. Center of gravity 183 in centroid setting portion of voice coil unit 182 consisting of voice coil 10 and coil holder 181 locates at a place in the direction anti-clockwise around center 5a of shaft for horizontal revolution 5 with respect to center line 8d of head supporting arm 8. Coil holder 181 is provided at one side edge with thickened part 181a, so as center of gravity 183 in centroid setting portion is not away much from center line 8d of head supporting arm 8.

These are the points of difference as compared with head supporting gear 150 of the third embodiment.

It is not essential to provide thickened portion 181a at one side edge of coil holder 181; voice coil unit 182 may be symmetrical with respect to center line 10a of voice coil 10. In the latter case, the location of center of gravity 183 in centroid setting portion of voice coil unit 182 naturally shifts to a place in the direction anti-clockwise around center 5a of shaft for horizontal revolution 5 with respect to center line 8d of head supporting arm 8.

Magnet 11 is magnetized in the same manner as in the first embodiment, namely the boundary between the pole N and the pole S coincides with center line 10a of voice coil 10's revolving motion in the state where magnetic head is at the outermost of recording region of recording medium 4.

When an electric current is delivered to voice coil 10, head supporting gear 180 is revolved and a magnetic force is generated in accordance with Fleming's rule between voice coil 10 and magnet 11. The revolving direction of head supporting gear 180 and the direction of vertical torque component effective to voice coil 10 are determined depending on direction of the electric current delivered to voice coil 10 and direction of magnetic flux of magnet 11 opposing to voice coil 10. These points remain the same as the case of the first embodiment.

Direction of vertical component of a magnetic force at revolution in loading direction, or in unloading direction, is opposite to that of the case of the first embodiment. Namely, when head supporting gear 180 is revolved towards inner circle of recording medium 4's recording region, vertical torque component works between voice coil 10 and magnet 11 in the direction opposite to that at the revolution in loading direction in the first embodiment. On the other hand, when an electric current is delivered to voice coil 10 for revolving towards unloading direction, vertical torque component works between voice coil 10 and magnet 11 in the direction opposite to that at the revolution in loading direction in the first embodiment.

Revolution torque component at head supporting gear 150 generated by VCM when a certain specific current is delivered to voice coil 10 is the same as the case of the first embodiment shown in FIG. 6A. Vertical torque component generated between magnet 11 and voice coil 10 in this situation is equal to the vertical torque component in the second embodiment shown in FIG. 14.

When an electric current is delivered to voice coil 10 for revolving head supporting gear 180, a bending resonance mode is generated with voice coil unit 182, in the same manner as in the first embodiment, by a magnetic force between voice coil 10 and magnet 11, with axis 30 for vertical revolution of head supporting gear 180 acting as fulcrum.

Meanwhile, center of gravity 183 in centroid setting portion of voice coil unit 182 locates at the side opposite to recording medium 4 in the direction of center 5a of shaft for horizontal revolution 5 with respect to a plane which contains axis 30 for vertical revolution and perpendicular to shaft for horizontal revolution 5, with a certain distance in the direction of center 5a of shaft for horizontal revolution 5 from axis 30 for vertical revolution which acts as fulcrum when voice coil unit 182 is bent by a magnetic force.

Namely, a first plane which contains center of gravity 183 in centroid setting portion of voice coil unit 182 consisting of voice coil 10 and coil holder 181 and perpendicular to center 5a of shaft for horizontal revolution 5 is disposed with a certain distance in the direction of center 5a of shaft for horizontal revolution 5 from a second plane which contains axis 30 for vertical revolution and perpendicular to the direction of center 5a of shaft for horizontal revolution 5.

So, when voice coil unit 182 is bent by a magnetic force between voice coil 10 and magnet 11, the location of center of gravity 183 in centroid setting portion of voice coil unit 182 subtly shifts in a plane perpendicular to center 5a of shaft for horizontal revolution 5, bringing about a force for revolving head supporting arm unit 184. Thus, like in the case of the first embodiment, vertical component of magnetic force between voice coil 10 and magnet 11 gives influence to frequency characteristics of head supporting gear 180.

Coil holder 181 is provided with thickened part 181a at a side edge which is closer to center line 8d of head supporting arm 8 in order that center of gravity 183 in centroid setting portion of voice coil unit 182 locates at a place in the direction anti-clockwise around center 5a of shaft for horizontal revolution 5 with respect to center line 8d of head supporting arm 8.

Therefore, relationship between the location of center of gravity 183 in centroid setting portion of voice coil unit 182 of head supporting gear 180 and the frequency characteristics of head supporting gear 180 can be made to be an advance phase, among other frequency characteristics of head supporting gear 180, by placing the center of gravity on the center line 8d of head supporting arm 8, or at a place in the direction anti-clockwise around center 5a of shaft for horizontal revolution 5 with respect to center line 8d of head supporting arm 8, like in the case of the first embodiment. This realizes an improved stability with location servo characteristic of head supporting gear 180, and an improved accuracy of head positioning.

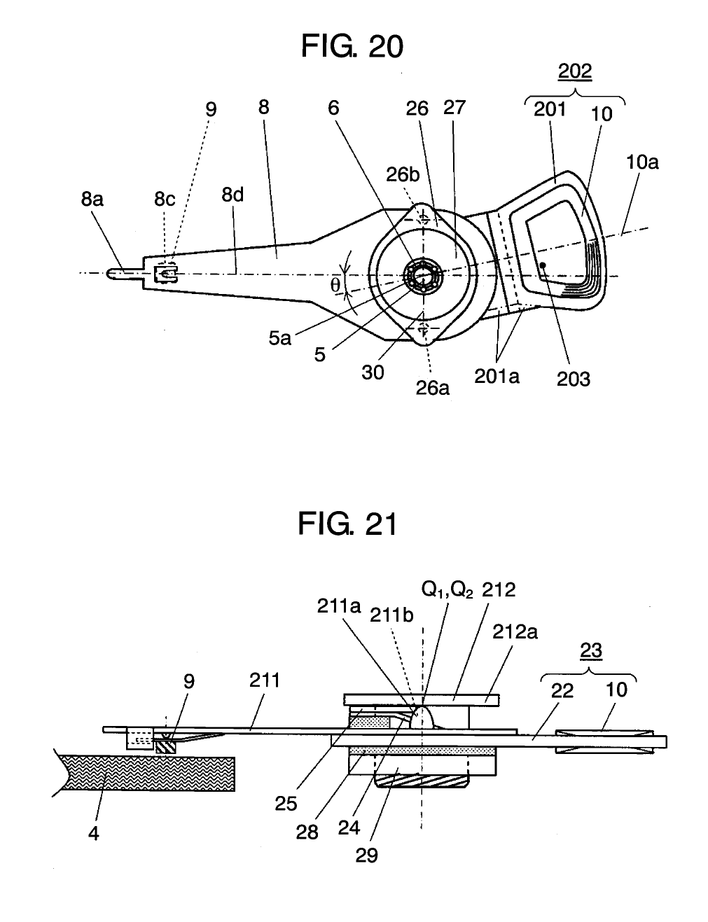

FIG. 20 is a plan view of other head supporting arm unit, used to describe the center of gravity in centroid setting portion of the voice coil unit. In the case of FIG. 20, where center line 10a of voice coil 10's revolving motion crosses center line 8d of head supporting arm 8 at an angle θ anti-clockwise around center 5a of shaft for horizontal revolution 5, thickened part 201a is provided in the same manner as in the first embodiment at a side edge of coil holder 201 which is closer to center line 8d of head supporting arm 8, viz. at a side edge in the direction anti-clockwise around center 5a of shaft for horizontal revolution 5. By so doing, center of gravity 203 in centroid setting portion of voice coil unit 202 is made to be locating at a place in the direction anti-clockwise around center 5a of shaft for horizontal revolution 5 with respect to center line 8d of head supporting arm 8.

As described in the above, the present fourth embodiment also provides the same advantages as those of the first, the second and the third embodiments. A disk drive which incorporates head supporting gear 180 in the fourth embodiment can reduce the overall size. Furthermore, since a head supporting gear can produce an advance phase at the resonance frequency, oscillation or the like instable characteristic does not appear at resonance frequency. A head supporting gear exhibits a stable location servo characteristic, and realizes a stabilized seek operation for a significantly improved head positioning accuracy.

Like in the first embodiment through the third embodiment, a magnetic disk drive incorporating the above-configured head supporting gear can reduce the overall size, offers a greater anti-shock performance, a faster access speed and more accurate head positioning.

A structure described in the first, second, third and the present fourth embodiments is formed of a pair of pivots 26a, 26b provided in pivot bearing 26, the summit points of these pivots 26a and 26b making contact with the upper surface of head supporting arm 8. However, the structure is not limited to the above-described configuration.

Axis for vertical revolution may be disposed perpendicular to the direction of center of shaft for horizontal revolution and to the center line of head supporting arm. Furthermore, respective summit points of the pair of pivots constituting an axis for vertical revolution may be disposed symmetrically to the center line of head supporting arm. Still further, axis for vertical revolution may contain the center of shaft for horizontal revolution.

By employing these structures, a head supporting gear can be revolved around axis for vertical revolution in the direction perpendicular to the surface of a recording medium. Thus, the center of revolution can be established accurately with a simple structure. Therefore, the head positioning can be controlled more precisely.

FIG. 21 is a side view which shows other formation of axis for vertical revolution, which is different from that in the first through the fourth embodiments. As shown in FIG. 21, the axis is formed with a pair of pivots 211a and 211b provided in head supporting arm 211, the summit points of respective pivots 211a and 211b making contact with flange 212a of bearing 212 at the lower surface. Also in the above structure, contact points Q1 and Q2, which are the points where pivots 211a and 211b make contact with the lower surface of bearing 212's flange 212a, can be disposed to be symmetrical with respect to shaft for horizontal revolution 5 (not shown), straight line containing contact points Q1 and Q2, or axis for vertical revolution, can contain the center of shaft for horizontal revolution 5 and perpendicular to the center line of head supporting arm 211 in the length direction, at the same time the middle point of Q1 and Q2 can be placed to be virtually meeting the center of shaft for horizontal revolution 5.

Furthermore, the above structure may be formed so as center of total mass of the members revolving around axis for vertical revolution is locating in a plane which contains the axis for vertical revolution and the center of shaft for horizontal revolution.

By so structuring, a head supporting arm unit will hardly be revolved around the axis for vertical revolution even when an impact is given from the outside in the direction of center of revolution axis. This helps implementing a head supporting gear having a superior anti-shock capability.

A disk drive in the present invention is formed of a recording medium which is revolved by a spindle motor, and a head supporting gear which is attached with a signal conversion element disposed opposed to the recording medium for recording signals on the recording medium and reproducing signals from the recording medium; the head supporting gear included in the disk drive being a head supporting gear of the above-described structure.

The above-configured disk drive can reduce its overall size, and realizes an enhanced anti-shock capability, a faster access speed and higher accuracy of head positioning.

The present invention includes a head supporting arm coupled via gimbals with head slider mounted with a head, which supporting arm being disposed so as it can revolve around a shaft for horizontal revolution in the direction parallel to the surface of a recording medium, and in the direction perpendicular to the surface of the recording medium around an axis for vertical revolution which is formed of a straight line containing the summit points of a pair of pivots; and a plate spring which is an elastic member for generating a load energizing force.

Furthermore, the present invention includes a voice coil unit formed of a voice coil and a coil holder which is fixed to a head supporting arm in a manner the center line of voice coil's revolving motion crosses the center line of the head supporting arm in the length direction with an angle θ (see FIG. 2), and a magnet and a yoke disposed so as each of them opposes to respective surface of voice coil in the direction of the center of shaft for horizontal revolution.

By so structuring a head supporting gear, a head supporting arm which is a constituent member of the head supporting gear can be manufactured with a material of high rigidity. So, the anti-shock property against a big shock from the outside can be enhanced, resonance frequency of head supporting arm can be raised higher, and a head supporting gear can be revolved at a high speed for quick head positioning.

Furthermore, since plate spring, or an elastic member, is provided as a separate item independent of the head supporting arm, a load on head slider can be set at a desired value with ease. This broadens the range of designing freedom.

Furthermore, a disk drive can reduce its overall size, produce an advance phase at resonance frequency of the head supporting gear; so, oscillation or the like instable characteristic does not appear at the resonance frequency. Thus, a head supporting gear can realize an improved location servo characteristic, stabilize seek operation for an improved accuracy in the head positioning.

Still further, a disk drive which incorporates a head supporting gear in accordance with the present invention can realize a downsizing, demonstrates an enhanced anti-shock performance, a very high access speed and precise head positioning.

### INDUSTRIAL APPLICABILITY

The present invention includes a head supporting arm coupled via gimbals with a head slider mounted with a head, which arm being disposed so as it can revolve around a shaft for horizontal revolution in the direction parallel to the surface of a recording medium, and in the direction perpendicular to the surface of the recording medium around an axis for vertical revolution formed of a straight line which contains the summit points of a pair of pivots; and a plate spring which is an elastic member for generating a load energizing force. A head supporting gear of the above configuration provides an enhanced anti-shock performance and realizes a high speed revolution for quick head positioning. With such advantages, the present invention is expected to find a broad application among the magnetic disk drives and non-contact type disk drives, such as an optical disk drive, a magneto-optical disk drive, etc.

1. A head supporting gear comprising
a head slider which contains a signal conversion element,
a head supporting arm coupled at one end with the head slider,
a coil holder which revolves integrated with the head supporting arm at an end opposite to the head slider around the center of a shaft for revolving the head supporting arm in the direction parallel to the surface of recording medium,
a voice coil attached fixed to the coil holder,
a pair of pivots which form an axis for the head supporting arm to revolve in the direction perpendicular to the surface of recording medium,
an elastic member for generating a force to energize the head slider towards the surface of recording medium around the axis for vertical revolution,
a magnet provided to be opposing to the voice coil in the direction of the center of shaft for horizontal revolution, and
a yoke provided at a side opposite to the magnet to be opposing to the voice coil in the direction of the center of shaft for horizontal revolution; wherein,
a first plane which contains center of gravity in centroid setting portion of a voice coil unit consisting of the voice coil and the coil holder and perpendicular to the direction of the center of shaft for horizontal revolution is disposed with a distance in the direction of the center of shaft for horizontal revolution from a second plane which contains the axis for vertical revolution and perpendicular to the direction of the center of shaft for horizontal revolution.

2. The head supporting gear of claim 1, wherein
the first plane which contains the center of gravity in the centroid setting portion of the voice coil unit and perpendicular to the direction of the center of shaft for horizontal revolution is in the recording medium side in the direction of the center of shaft for horizontal revolution with respect to the second plane which contains the axis for vertical revolution and perpendicular to the direction of the center of shaft for horizontal revolution,
the magnet is in the side opposite to the recording medium with respect to the voice coil in the direction of the center of shaft for horizontal revolution, and
the center of gravity in the centroid setting portion of the voice coil unit locates at a place in the direction anti-clockwise around the center of shaft for horizontal revolution with respect to the center line of the head supporting arm.

3. The head supporting gear of claim 1, wherein
the first plane which contains the center of gravity in the centroid setting portion of the voice coil unit and perpendicular to the direction of the center of shaft for horizontal revolution is in the recording medium side in the direction of the center of shaft for horizontal revolution with respect to the second plane which contains the axis for vertical revolution and perpendicular to the direction of the center of shaft for horizontal revolution,
the magnet is in the recording medium side with respect to the voice coil in the direction of the center of shaft for horizontal revolution, and
the center of gravity in the centroid setting portion of the voice coil unit locates at a place in the direction clockwise around the center of shaft for horizontal revolution with respect to the center line of the head supporting arm.

4. The head supporting gear of claim 1, wherein
the first plane which contains the center of gravity in the centroid setting portion of the voice coil unit and perpendicular to the direction of the center of shaft for horizontal revolution is in the side opposite to the recording medium in the direction of the center of shaft for horizontal revolution with respect to the second plane which contains the axis for vertical revolution and perpendicular to the direction of the center of shaft for horizontal revolution,
the magnet is in the side opposite to the recording medium in the direction of the center of shaft for horizontal revolution with respect to the voice coil, and
the center of gravity in the centroid setting portion of the voice coil unit locates at a place in the direction clockwise around the shaft for horizontal revolution with respect to the center line of the head supporting arm.

5. The head supporting gear of claim 1, wherein
the first plane which contains the center of gravity in the centroid setting portion of the voice coil unit and perpendicular to the direction of the center of shaft for horizontal revolution is in the side opposite to the recording medium in the direction of the center of shaft for horizontal revolution with respect to the second plane which contains the axis for vertical revolution and perpendicular to the direction of the center of shaft for horizontal revolution,
the magnet is in the recording medium side in the direction of the center of shaft for horizontal revolution with respect to the voice coil, and
the center of gravity in the centroid setting portion of the voice coil unit locates at a place in the direction anti-clockwise around the shaft for horizontal revolution with respect to the center line of the head supporting arm.

6. The head supporting gear recited in claim 1, wherein
a boundary between the pole N and the pole S of the magnet is determined so as the center line of the voice coil coincides with the boundary in the state where the signal conversion element of the head supporting arm is at the outermost of the recording region of the recording medium.

7. The head supporting gear recited in claim 1, wherein
the axis for vertical revolution is perpendicular to the direction of the center of shaft for horizontal revolution and the center line of the head supporting arm.

8. The head supporting gear recited in claim 1, wherein
summit points of a pair of pivots forming the axis for vertical revolution are disposed symmetrically with respect to the center line of the head supporting arm.

9. The head supporting gear recited in claim 1, wherein
the axis for vertical revolution contains the center of shaft for horizontal revolution.

10. The head supporting gear recited in claim 1, wherein
the center of the total mass of those members revolving around the axis for vertical revolution locates in a plane which contains the axis for vertical revolution and the center of shaft for horizontal revolution.

11. A disk drive comprising
a recording medium which is revolved by a spindle motor, and
a head supporting gear mounted with a signal conversion element for recording signals in the recording medium or reproducing signals from the recording medium disposed opposed to the recording medium; wherein
the head supporting gear is a head supporting gear recited in claim 1.

12. A disk drive comprising
a recording medium which is revolved by a spindle motor, and
a head supporting gear mounted with a signal conversion element for recording signals in the recording medium or reproducing signals from the recording medium disposed opposed to the recording medium; wherein
the head supporting gear is a head supporting gear recited in claim 2.

13. A disk drive comprising
a recording medium which is revolved by a spindle motor, and
a head supporting gear mounted with a signal conversion element for recording signals in the recording medium or reproducing signals from the recording medium disposed opposed to the recording medium; wherein
the head supporting gear is a head supporting gear recited in claim 3.

14. A disk drive comprising
a recording medium which is revolved by a spindle motor, and
a head supporting gear mounted with a signal conversion element for recording signals in the recording medium or reproducing signals from the recording medium disposed opposed to the recording medium; wherein
the head supporting gear is a head supporting gear recited in claim 4.

15. A disk drive comprising
a recording medium which is revolved by a spindle motor, and
a head supporting gear mounted with a signal conversion element for recording signals in the recording medium or reproducing signals from the recording medium disposed opposed to the recording medium; wherein
the head supporting gear is a head supporting gear recited in claim 5.
